(19) United States
(12) Patent Application Publication
(10) Pub. No.: US 2026/0084422 A1
(43) Pub. Date: Mar. 26, 2026

(54) LIQUID DISCHARGE HEAD AND LIQUID DISCHARGE APPARATUS

(71) Applicant: CANON KABUSHIKI KAISHA, Tokyo (JP)

(72) Inventors: SOICHIRO NAGAMOCHI, Kanagawa (JP); TOSHIO NEGISHI, Kanagawa (JP)

(21) Appl. No.: 19/332,861

(22) Filed: Sep. 18, 2025

(30) Foreign Application Priority Data
Sep. 25, 2024 (JP) 2024-166303

(51) Int. Cl. B41J 2/045; B41J 2/14; B41J 2/16

(52) U.S. Cl. CPC B41J 2/04591; B41J 2/04541; B41J 2/04543; B41J 2/04573; B41J 2/0458; B41J 2/14072; B41J 2002/14491; B41J 2/1601; B41J 2202/12

(57) ABSTRACT

A liquid discharge head includes: a discharging module which has a discharging drive element and a discharging heater capable of being electrically connected to the discharging drive element; a circulating module which is arranged in pair with the discharging module and has a circulating drive element and a circulating heater capable of being electrically connected to the circulating drive element; and a pulse width controller which differentiates a discharging pulse width for controlling the discharging drive element to a conductive state from a circulating pulse width for controlling the circulating drive element to a conductive state.

### BACKGROUND

### Field of the Technology

The present disclosure relates to a liquid discharge head which discharges a liquid while circulating the liquid and liquid discharge apparatus.

### Description of the Related Art

Conventionally, in circulation type, of liquid discharge apparatuses which circulate a liquid (referred to also as ink), it is know that a liquid discharge apparatus which makes ink in a circulation flow path in communication with a discharge orifices circulate by a circulating drive element which is different from a discharge drive element for discharging ink. International Publication No. WO 2018/190872 (referred to as Literature 1 hereinafter) discloses a technique of selectively driving a discharging drive element and a circulating drive element.

However, according to the technique disclosed in Literature 1, even if the driving power required for the discharging drive element and the driving power required for the circulating drive element are different, each of driving pulse widths of the discharging drive element and of the circulating drive element is the same. Hence, there is a case where driving power cannot be appropriately supplied to at least one of the discharging drive element and the circulation drive element.

### SUMMARY

An object of the present disclosure is to make it possible to appropriately supply a driving power to each of a discharging drive element and a circulating drive element.

A liquid discharge head according to an aspect of the present disclosure includes: a discharging module for having a discharging drive element and a discharging heater capable of being electrically connected to the discharging drive element; a circulating module for being arranged in pair with the discharging module and for having a circulating drive element and a circulating heater capable of being electrically connected to the circulating drive element; and a pulse width controller for differentiating a discharging pulse width for controlling the discharging drive element to a conductive state from a circulating pulse width for controlling the circulating drive element to a conductive state.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view schematically showing a liquid discharge apparatus with a main ink tank as a liquid reservoir provided outside of a liquid discharge head.

FIG. 1B is a perspective view schematically showing a liquid discharge apparatus with an ink sub tank provided directly above a liquid discharge head.

FIG. 2A is an exploded perspective view of the liquid discharge head in FIG. 1.

FIG. 2B is a diagram showing an example in which one discharge element substrate is provided for four colors.

FIG. 2C shows an example in which one discharge element substrate is provided for two colors.

FIG. 2D is a diagram showing an example in which one discharge element substrate is provided for one color.

FIG. 3 is a diagram showing an example of a circuit configuration of the discharge element substrate in FIG. 2.

FIG. 4A is a functional block diagram of a circuit configuration of a control data supply circuit.

FIG. 4B is a diagram showing a circuit configuration of a circulating group control circuit in FIG. 4A.

FIG. 5 is a diagram showing an example of a circuit configuration of a pulse width shortening circuit in FIG. 3.

FIG. 6A is a diagram showing a pulse shape at 6A in FIG. 5.

FIG. 6B is a diagram showing a pulse shape at 6B in FIG. 5.

FIG. 6C is a diagram showing a pulse shape at 6C in FIG. 5.

FIG. 7 is a diagram showing an example circuit configuration of a delay circuit in FIG. 5.

FIG. 8 is a diagram showing another example circuit configuration of the delay circuit in FIG. 5.

FIG. 9 is a plan view of a discharge element substrate.

FIG. 10 is a diagram showing an example general configuration of a liquid discharge apparatus according to a second embodiment.

FIG. 11 is a diagram showing an example of a circuit configuration of a pulse width extension circuit in FIG. 10.

FIG. 12A is a diagram showing a pulse shape at 12A in FIG. 11.

FIG. 12B is a diagram showing a pulse shape at 12B in FIG. 11.

FIG. 12C is a diagram showing a pulse shape at 12C in FIG. 11.

FIG. 13 is a diagram showing an example general configuration of a liquid discharge apparatus according to a third embodiment.

FIG. 14 is a diagram showing an example of a circuit configuration of a pulse width generating circuit in FIG. 13.

FIG. 15 is a diagram showing an example change of a pulse in the pulse width generating circuit in FIG. 14.

### DESCRIPTION OF THE EMBODIMENTS

Hereinafter, embodiments of the present disclosure will be described in detail in reference to the attached drawings. The following embodiments are not intended to limit the matters disclosed herein. In addition, all the combinations of features described in the following embodiments are not necessarily essential for the solution of the present disclosure. Herein, the same constituent elements will be designated with the same reference sign.

### (Overview)

Conventionally, it has been pointed out that there is a risk that a volatile constituents in ink evaporates from the discharge orifices through which the ink is discharged, causing the ink in the discharge orifices to thicken. Such thickening of the ink may cause a change in the ink discharging speed and my result in discharge defects such as landing accuracy of the ink. In particular, when the ink discharge operation pauses for a long period of time, the increase in the ink viscosity becomes significant. As a result, solid constituents in the ink adheres to the inside of the discharge orifices, increasing the flow resistance of the ink and making it prone to causing defective discharge of the ink.

One known method for dealing with such a thickening of the ink is to flow fresh liquid into the discharge orifices in the liquid chamber. One method for flowing a liquid is to circulate the liquid in the head by a pressure difference using a main body pump which is provided separately from the fluid die which discharges the liquid. Alternatively, a method is known in which a circulation element is provided in the fluid die itself to circulate the liquid. Alternatively, a method is known in which a liquid is circulated by the bubble by the heating element as the circulation element in the fluid die itself.

Literature 1 discloses an arrangement in which a fluid die is provided with a flow energy generating element and a liquid is circulated through a discharge orifices array between opposite ends of a flow path extending to intersect with the discharge orifices array.

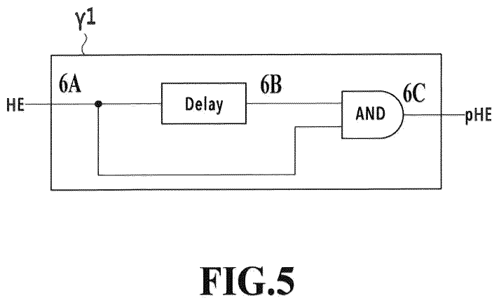

However, the discharging heater and the circulating heater have different roles and therefore require different amounts of driving energy. In addition, the required amount of energy varies with the configuration of the flow path, the size of each heater, or the like. On the other hand, from the viewpoint of energy conservation, durability and the like, it is desirable to apply an appropriate driving pulse according to each configuration. With the circuit configuration shown in FIG. 5 of Literature 1, signals of the same driving pulse width (referred to as a pulse width as required, hereinafter) are input to both the discharging heater and the circulating heater, one of the discharging heater and the circulating heater may receive insufficient or excessive driving energy. If separate heat enable terminals are provided in order to change the pulse width according to whether the pulse is applied to the discharging heater or the circulating heater, the number of pads increases, the signal lines outside of the recording element substrate increase, and the cost of the liquid discharge head increases.

In view of this, the feature in the present disclosure is to differentiate a discharging pulse width for controlling the discharging drive element to a conductive state from a circulating pulse width for controlling the circulating drive element to a conductive state. Hence, if the pulse width for which the power consumption is to be reduced is relatively shortened, the balance of the overall power consumption can be adjusted. Therefore, the power shortage and surplus power of each of the discharging drive element and the circulation drive element can be solved.

### First Embodiment

### <Liquid Discharge Apparatus 50>

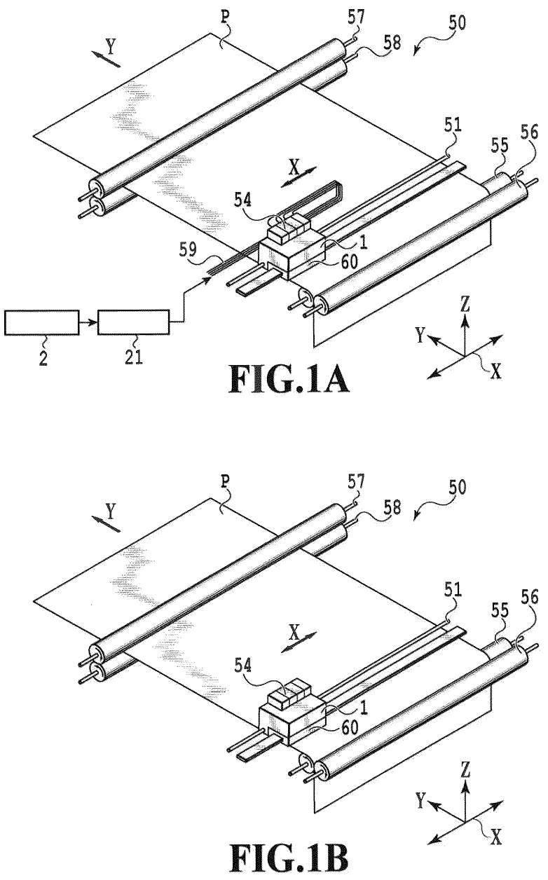

FIGS. 1A and 1B are diagrams showing example general configurations of a liquid discharge apparatus 50 according to a first embodiment. FIG. 1A is a perspective view schematically showing a liquid discharge apparatus 50 with an ink tank 2 as a liquid reservoir provided outside of a liquid discharge head 1. FIG. 1B is a perspective view schematically showing a liquid discharge apparatus 50 with an ink sub tank 54 provided directly above a liquid discharge head 1. Parts common to FIGS. 1A and 1B will be first described.

The liquid discharge apparatus 50 includes the liquid discharge head 1 and conveyance rollers 55, 56, 57 and 58. The liquid discharge head 1 can scan a discharge medium P in a direction X that intersects with a conveyance direction Y of the discharge medium P. The liquid discharge head 1 is mounted on a carriage 60. The carriage 60 reciprocates in a main scan direction (referred to also as the direction X) along a guide shaft 51. The conveyance rollers 55, 56, 57 and 58 convey the discharge medium P in a sub scan direction (referred to also as the conveyance direction Y) that intersects with (is orthogonal to, in this embodiment) the main scan direction. That is, the liquid discharge apparatus 50 constitutes a serial type ink jet discharge apparatus that forms an image by discharging a liquid from the liquid discharge head 1 onto the discharge medium P conveyed in the conveyance direction Y while moving the liquid discharge head 1 in the direction X. Note that the application of the present disclosure is not limited to the serial type ink jet discharge apparatus. The present disclosure can also be applied to a page-wide type ink jet discharge apparatus that forms an image by discharging a liquid onto the discharge medium P conveyed in the conveyance direction Y by using a line head (page-wide type head) that is elongated in the page width direction of the discharge medium P. Note that in FIGS. 1A and 1B, a direction Z is the vertical direction. That is, the direction Z is a direction that intersects with (is orthogonal to, in this embodiment) an X-Y plane defined by the direction X and the conveyance direction Y.

The liquid discharge head I can discharge four types of ink, black (K), cyan (C), magenta (M) and yellow (Y). The liquid discharge head I can form a full-color image with these four types of ink. Note that the inks that can be discharged from the liquid discharge head 1 are not limited to the four types of ink described above. For example, the present disclosure can also be applied to a liquid discharge head I for discharging another kind of ink, such as spot color ink. That is, the types and number of inks discharged from the liquid discharge head are not limited.

Next, differences between FIGS. 1A and 1B will be described. In FIG. 1A, the ink sub tank 54 is mounted on the liquid discharge head 1. Four ink supply tubes (liquid communication paths) 59 are attached to the ink sub tank 54. The liquid discharge apparatus 50 further includes an ink tank 2 and an external pump 21. The ink tank 2 stores ink. The ink stored in the ink tank 2 is supplied to the ink sub tank 54 through the four ink supply tubes 59 under the driving force of the external pump 21. On the other hand, in FIG. 1B, the ink sub tank 54 is provided directly above the liquid discharge head1. FIG. 1B differs from FIG. 1A in that the ink tank 2 is not provided outside of the liquid discharge head 1, and therefore, the four ink supply tubes 59 are not attached, and the external pump 21 is not provided. Note that in both FIGS. 1A and 1B, the liquid discharge head 1 may be provided integrally with the ink sub tank 54 and may be configured so that the liquid discharge head 1 can be removably attached to the carriage 60. Alternatively, the ink sub tank 54 may be provided integrally with the carriage 60 and the ink sub tank 54 alone may be removably attached to the carriage 60. The following description will be made with reference to the configuration in FIG. 1A.

### <Liquid Discharge Head 1>

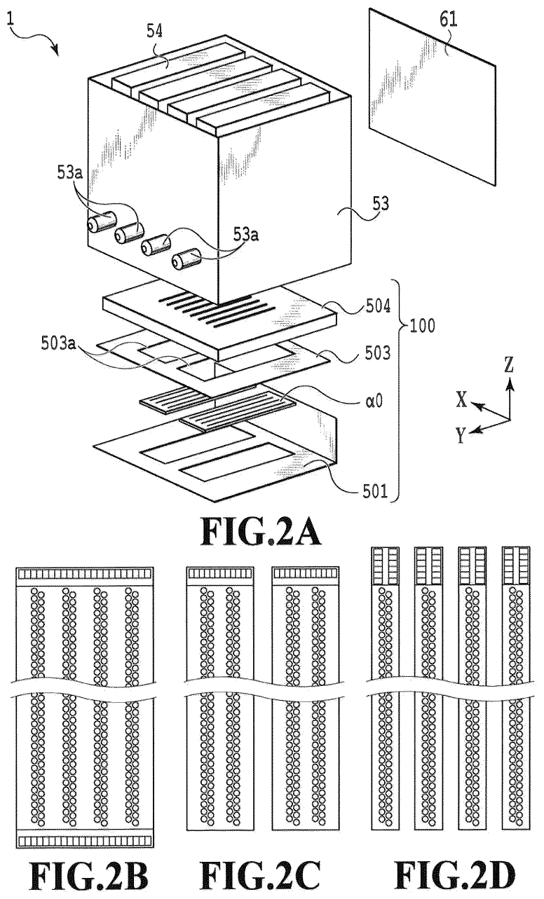

FIGS. 2A, 2B, 2C and 2D are diagrams showing an example basic configuration of the liquid discharge head 1 in FIG. 1. FIG. 2A is an exploded perspective view of the liquid discharge head 1 in FIG. 1. FIGS. 2B, 2C and 2D are general views of a discharge element substrate α0. The liquid discharge head 1 includes a housing portion 53, the ink sub tank 54, an electric contact substrate 61 and a discharge element unit 100. The ink sub tank 54 is housed in the housing portion 53. The discharge element unit 100 is provided in a bottom part of the housing portion 53. On a face of the housing portion 53, four joints 53a to be connected to the four ink supply tubes 59 corresponding to the four types of ink are provided. In other words, separate ink supply paths are provided for different types of ink. To the face opposite to the face on which the four joints 53a are provided, the electric contact substrate 61 is fixed. The electric contact substrate 61 is electrically connected to an electrical connection part of the carriage 60 in the state where the liquid discharge head 1 is mounted on the carriage 60. This connection allows the electric contact substrate 61 to receive an electric signal from the main unit of the liquid discharge apparatus. The electric signal received by the electric contact substrate 61 is transmitted to the discharge element substrate α0 via an electric wiring member 501.

The discharge element unit 100 includes a first supporting member 504, a second supporting member 503, the discharge element substrate α0 and the electric wiring member 501. An ink supply port and an ink collection port are provided in the first supporting member 504. An opening 503a is provided in the second supporting member 503. The discharge element substrate α0 is bonded and fixed to the first supporting member 504. The first supporting member 504 is bonded and fixed to the second supporting member 503. The second supporting member 503 holds the electric wiring member 501 in such a manner that the electric wiring member 501 is electrically connected to the discharge element substrate α0. The electric wiring member 501 applies an electric signal for discharging ink or an electric signal for circulating ink to the discharge element substrate α0. The electric signal for discharging ink and the electric signal for circulating ink will be described in detail later.

FIG. 2B shows an example in which one discharge element substrate α0 is provided for four colors. The four colors are black, cyan, magenta and yellow, for example, and the discharge element substrate α0 is divided into arrays on a color basis. The arrays each extend in the conveyance direction Y and are spaced apart from each other in the direction X. Each array includes a plurality of discharge orifices, which are arranged at regular intervals in the Y direction. Note that the discharge orifices in each array may be arranged in a line in the Y direction, rather than being spaced apart from each other in the X direction. Alternatively, the discharge orifices for four colors may be arranged in a total of five lines, only the discharge orifices for black being arranged in two lines and the discharge orifices for the other three colors being each arranged in one line. FIG. 2C shows an example in which one discharge element substrate α0 is provided for two colors. That is, one liquid discharge head 1 may be provided with two discharge element substrates α0. Alternatively, two liquid discharge heads 1 each provided with one such discharge element substrate α0 may be prepared. FIG. 2D shows an example in which one discharge element substrate α0 is provided for one color. That is, one liquid discharge head 1 may be provided with four discharge element substrates α0. Alternatively, four liquid discharge heads 1 each provided with one such discharge element substrate α0 may be prepared. In the cases where a plurality of separate discharge element substrates α0 are used as in the cases shown in FIGS. 2C and 2D, all the discharge element substrates α0 need not have the same length. Furthermore, the discharge element substrate α0 may be provided for various other numbers and combinations of colors, and the same holds true for cases where the total number of colors is greater than 4. In the following, the electric signal for discharging ink and the electric signal for circulating ink will be described in detail with reference to use cases of circuit configurations and the like.

### (Discharge Element Substrate α0)

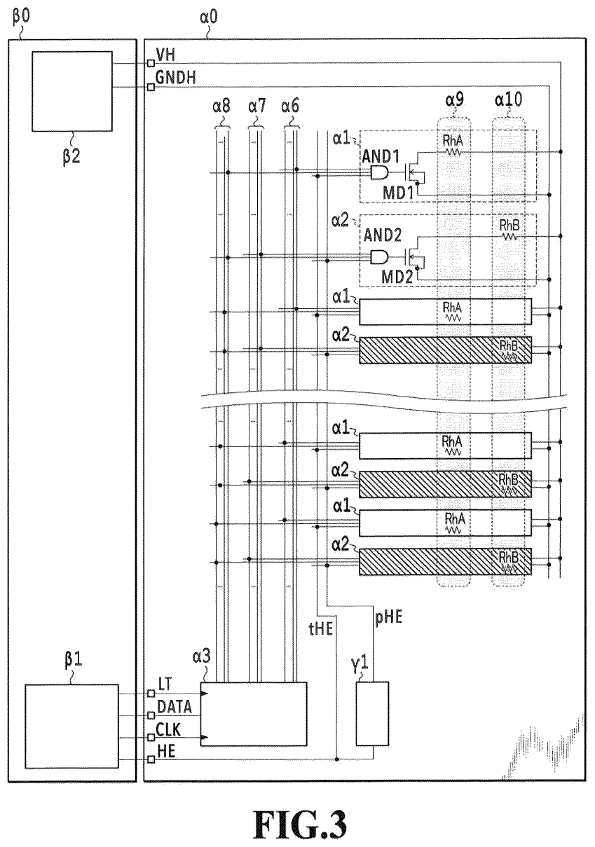

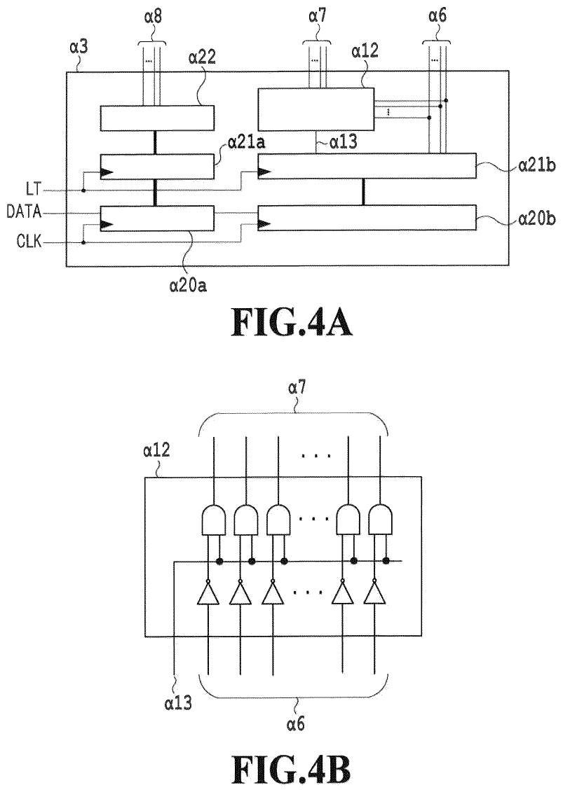

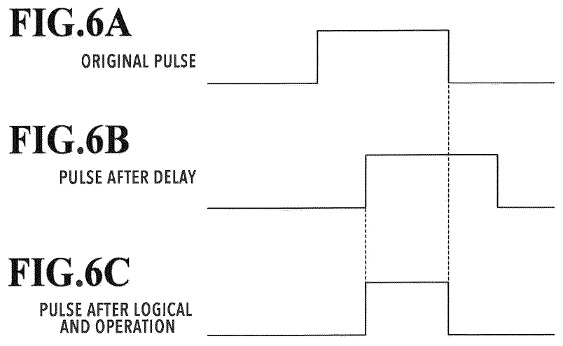

FIG. 3 is a diagram showing an example of the circuit configuration of the discharge element substrate α0 in FIG. 2. FIG. 4 is a diagram showing an example of the circuit configuration of a control data supply circuit α3 in FIG. 3. FIG. 4A is a functional block diagram of the circuit configuration of the control data supply circuit α3. FIG. 4B is a diagram showing a circuit configuration of a circulating group control circuit α12 in FIG. 4A. FIG. 5 is a diagram showing an example of the circuit configuration of a pulse width shortening circuit γ1. FIG. 6 is a diagram showing an example change of a pulse in the pulse width shortening circuit γ1 in FIG. 5. Various signals are supplied to the discharge element substrate α0 from a main substrate β0. The main substrate β0 includes a controller β1 and a power supply circuit β2. The controller β1 mainly includes a ROM, a RAM and a CPU and supplies various electric signals to the discharge element substrate α0 to control the liquid discharge head 1. The controller β1 supplies a heat enable signal HE, a latch signal LT, a data signal DATA and a clock signal CLK to the discharge element substrate α0. The signals will be described in detail later. The power supply circuit β2 applies a power supply voltage VH to the discharge element substrate α0. The power supply circuit β2 and the discharge element substrate α0 are connected to each other at GNDH. GNDH serves as a ground potential.

### (Overview of Wiring)

The discharge element substrate α0 in FIG. 3 includes a plurality of discharging modules α1, a plurality of circulating modules α2, the control data supply circuit α3 and the pulse width shortening circuit γ1. The circulating module α2 is arranged in pair with the discharging module α1. Therefore, the number of the circulating modules α2 is equal to the number of the discharging modules α1. Between the plurality of discharging module α1 and the control data supply circuit α3, discharging group selection signal wiring α6, common time-division selection signal wiring α8 and transmission wiring for a discharging heat enable signal tHE are provided. Between the plurality of circulating module α2 and the control data supply circuit α3, circulating group selection signal wiring α7, the common time-division selection signal wiring α8 and transmission wiring for a circulating heat enable signal pHE are provided.

Note that the discharging heat enable signal tHE is the heat enable signal HE transmitted without change. On the other hand, the circulating heat enable signal pHE is the heat enable signal HE having passed through the pulse width shortening circuit γ1. As described in detail later, the pulse width shortening circuit γ1 is a circuit that reduces the pulse width of an input signal and outputs the signal with the reduced pulse width. Therefore, the pulse width of the circulating heat enable signal pHE is shorter than the pulse width of the discharging heat enable signal tHE. Furthermore, the common time-division selection signal wiring α8 is shared by the discharging module α1 and the circulating module α2, and this contributes to shortening the amount of transferred serial data described later and shortening the layout area of the signal wiring on the discharge element substrate α0.

### (Discharging Module α1)

The discharging module α1 in FIG. 3 includes a discharging heater RhA, a discharging drive element MD1 and a discharging logic circuit AND1. The discharging heater RhA is formed by an electrothermal conversion element, for example. The discharging heater RhA is in the state where the power supply voltage VH is applied to the discharging heater RhA, and when the discharging drive element MD1 is conductive, a current flows through the discharging heater RhA. The discharging drive element MD1 is formed by a metal-oxide-semiconductor field effect transistor (MOSFET), for example. Note that the discharging drive element MD1 need not be formed by a MOSFET. For example, the discharging drive element MD1 may be formed by a bipolar transistor. Alternatively, the discharging drive element MD1 may be formed by an insulated gate bipolar transistor (IGBT). The discharging logic circuit AND1 selectively drives the discharging drive element MD1. The discharging heat enable signal tHE, the discharging group selection signal and a common time-division selection signal are input to the input side of the discharging logic circuit AND1. The discharging heat enable signal tHE is the heat enable signal HE transmitted from the controller R 1 and transferred without change. The discharging heat enable signal tHE controls the current pulse width of the discharging drive element MD1, that is, the period for which the drain and source of the discharging drive element MD1 are conductive and a current is kept flowing between the drain and source of the discharging drive element MD1. The discharging heat enable signal tHE is a signal for adjusting the current pulse width so that a desired amount of thermal energy can be generated by considering various manufacturing variations. The various manufacturing variations include manufacturing variations of the resistance value of the discharging heater RhA mounted on the discharge element substrate α0 and manufacturing variations of the power supply circuit β2, for example. The various manufacturing variations further include a voltage drop on power supply-side wiring at the time when a plurality of heaters, such as the discharging heater RhA and a circulating heater RhB, are simultaneously driven. Note that the heaters simultaneously driven here are the discharging heater RhA and a circulating heater RhB that is not arranged in pair with the discharging heater RhA. The heat enable signal HE can be transmitted from the controller β1 through an external input terminal (not shown) provided on the discharge element substrate α0. The discharging group selection signal is supplied on the discharging group selection signal wiring α6. The discharging time-division selection signal is supplied on the common time-division selection signal wiring α8. The output side of the discharging logic circuit AND1 is connected to the gate of the discharging drive element MD1. Therefore, when all the signals input to the input side of the discharging logic circuit AND1 are 1, a voltage is applied to the gate of the discharging drive element MD1, and the drain and source of the discharging drive element MD1 are conductive. When the drain and source of the discharging drive element MD1 are conductive, a current flows through the discharging heater RhA, so that the discharging heater RhA generates heat. Through this series of operations, the ink can be bubbled and discharged onto the discharge medium P. Although an example has been described in which the discharging heater RhA is formed by an electrothermal conversion element, this is not intended to be limiting. For example, the discharging heater RhA may be formed by a piezoelectric element.

### (Circulating Module α2)

The circulating module α2 in FIG. 3 includes a circulating heater RhB, a circulating drive element MD2 and a circulating logic circuit AND2. The circulating heater RhB is formed by an electrothermal conversion element, for example. The circulating heater RhB is in the state where the power supply voltage VH is applied to the circulating heater RhB, and when the circulating drive element MD2 is conductive, a current flows through the circulating heater RhB. The circulating drive element MD2 is formed by a metal-oxide-semiconductor field effect transistor (MOSFET), for example. Note that the circulating drive element MD2 need not be formed by a MOSFET. For example, the circulating drive element MD2 may be formed by a bipolar transistor. Alternatively, the circulating drive element MD2 may be formed by an insulated gate bipolar transistor (IGBT). The circulating logic circuit AND2 selectively drives the circulating drive element MD2. The circulating heat enable signal pHE, the circulating group selection signal and the common time-division selection signal are input to the input side of the circulating logic circuit AND2. The circulating heat enable signal pHE is transmitted from the controller β1 via the pulse width shortening circuit γ1. The pulse width shortening circuit γ1 will be described in detail later. The circulating heat enable signal pHE controls the current pulse width of the circulating drive element MD2, that is, the period for which the drain and source of the circulating drive element MD2 are conductive and a current is kept flowing between the drain and source of the circulating drive element MD2. The circulating heat enable signal pHE is a signal for adjusting the current pulse width so that a desired amount of thermal energy can be generated by considering various manufacturing variations. The various manufacturing variations include manufacturing variations of the resistance value of the circulating heater RhB mounted on the discharge element substrate α0 and manufacturing variations of the power supply Circuit β2, for example. The various manufacturing variations further include a voltage drop on power supply-side wiring at the time when a plurality of heaters, such as the circulating heater RhB and the discharging heater RhA, are simultaneously driven. Note that the circulating heat enable signal pHE can be transmitted from the controller β1 through an external input terminal (not shown) provided on the discharge element substrate α0. The circulating group selection signal is supplied on the circulating group selection signal wiring α7. The output side of the circulating logic circuit AND2 is connected to the gate of the circulating drive element MD2. Therefore, when all the signals input to the input side of the circulating logic circuit AND2 are 1, a voltage is applied to the gate of the circulating drive element MD2, and the drain and source of the circulating drive element MD2 are conductive. When the drain and source of the circulating drive element MD2 are conductive, a current flows through the circulating heater RhB, so that the circulating heater RhB generates heat. Through this series of operations, a bubble in the ink can be developed, and a circulatory flow can be produced in the ink circulation flow path. Although an example has been described in which the circulating heater RhB is formed by an electrothermal conversion element, this is not intended to be limiting. For example, the circulating heater RhB may be formed by a piezoelectric element.

### (Control Data Supply Circuit α3)

The control data supply circuit α3 in FIG. 4 includes shift registers α20a and α20b, latch circuits α21a and α21b, a decoder circuit α22 and a circulating group control circuit al 2. The control data supply circuit α3 is further provided with an external input terminal. The clock signal CLK, the data signal DATA and the latch signal LT are supplied from the controller R 1 to the control data supply circuit α3 via the external input terminal. The clock signal CLK is a signal used for serial data transfer of the data signal DATA to the shift registers α20a and α20b. The data signal DATA includes selection information about the discharging module α1 and selection information about the circulating module α2. The latch signal LT obtains and holds information stored in each of the shift registers α20a and α20b at every latch cycle. The decoder circuit α22 and the circulating group control circuit α12 will be described in detail later.

### (Pulse Width Shortening Circuit γ1)

As shown in FIG. 5, the pulse width shortening circuit γ1 includes a delay circuit and an AND circuit. FIG. 6A is a diagram showing a pulse shape at (a) in FIG. 5. FIG. 6B is a diagram showing a pulse shape at (b) in FIG. 5. FIG. 6C is a diagram showing a pulse shape at (c) in FIG. 5. Here, a case is assumed where the pulse width of the heat enable signal HE is 0.8 μs. In addition, when the heat enable signal HE is input to the pulse width shortening circuit γ1, the heat enable signal HE is split before being input to the delay circuit. One of the split signals is input to the delay circuit, and the other split signal bypasses the delay circuit and is input to the AND circuit. The AND circuit receives the signal input thereto by bypassing the delay circuit and the signal output from the delay circuit. Compared with FIG. 6A, the rising edge of the heat enable signal HE in FIG. 6B, which has passed through the delay circuit, is delayed by 0.2 μs, for example. Therefore, the pulse width of the signal output from the AND circuit is 0.6 μs. That is, the pulse width of the circulating heat enable signal pHE is 0.6 μs, while the pulse width of the discharging heat enable signal tHE is 0.8 μs. Therefore, when the amount of delay of the delay circuit is 0.2 μs, the difference between the discharging heat enable signal tHE and the circulating heat enable signal pHE is 0.2 μs. That is, when the amount of delay of the delay circuit is 0.2 μs or less, the difference between the pulse width of the discharging heat enable signal tHE and the pulse width of the circulating heat enable signal pHE is 0.2 μs or less. Therefore, the difference between the pulse width of the discharging heat enable signal tHE and the pulse width of the circulating heat enable signal pHE can be set to be equal to or less than the amount of delay of the delay circuit. Therefore, the difference between the pulse width of the discharging heat enable signal tHE and the pulse width of the circulating heat enable signal pHE can be controlled to be equal to or less than 0.2 μs, which is the amount of delay of the delay circuit.

### (Delay Circuit)

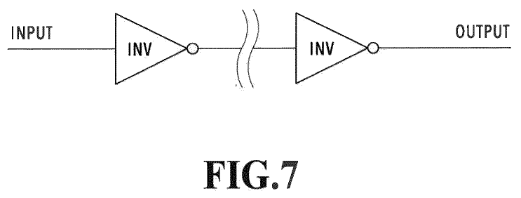

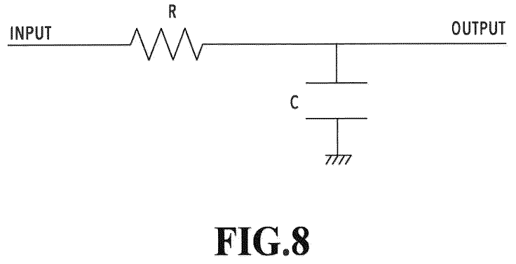

FIG. 7 is a diagram showing an example circuit configuration of the delay circuit in FIG. 5. As shown in FIG. 7, the delay circuit includes a plurality of inverter circuits. The inverter circuits are connected in series. It is assumed that the delay amount of one inverter circuit is 10 ns. On this assumption, when twenty inverter circuits are connected in series, the pulse of the signal is delayed by 0.2 μs compared with the original pulse. Note that the number of the inverter circuits connected to each other is not limited to twenty. For example, the delay amount of one inverter circuit may be 20 ns, and ten inverter circuits may be connected in series. Alternatively, the number of the inverter circuits connected to each other may be separately controlled in the discharge element substrate α0 by an external signal, and a desired number of inverter circuits to be connected to each other may be specified for each driving so that the amount of reduction of the pulse width can be adjusted. Alternatively, the delay circuit may be implemented by a field programmable gate array (FPGA). Alternatively, instead of connecting a plurality of inverter circuits in series, the signal may be delayed by an RC circuit. FIG. 8 is a diagram showing another example circuit configuration of the delay circuit in FIG. 5. As shown in FIG. 8, the pulse of the signal may be delayed by an RC circuit including a resistor R and a capacitor C connected in series with each other. Specifically, the resistor R is connected between an input terminal and an output terminal, and the capacitor C is connected between the output terminal and GND. The delay time is determined by the product of the resistance R and the capacitance C, and any delay time can be set according to resistance R by capacitance C. For example, when a resistor R having a resistance of 10 K ohm and a capacitor C having a capacitance of 20 pF are used, the delay time is 0.2 μs. Therefore, the pulse can be delayed by approximately 0.2 μs compared with the original pulse. Therefore, a plurality of types of resistors R and a plurality of types of capacitors C may be previously provided in the delay circuit, and a desired resistor Rand a desired capacitor may be selected by an external signal for each driving so that the delay amount of the pulse and the amount of reduction of the pulse width can be adjusted.

As can be seen from the above description, the circulating heat enable signal pHE having passed through the pulse width shortening circuit γ1 has a shorter pulse width than the discharging heat enable signal tHE that does not pass through the pulse width shortening circuit γ1, and these signals can have different pulse widths. Although this embodiment has been described with reference to an example in which the pulse width of the circulating heat enable signal pHE is reduced by the pulse width shortening circuit γ1, this is not intended to be limiting. A wiring arrangement is also possible in which the discharging heat enable signal tHE passes through the pulse width shortening circuit γ1 and the circulating heat enable signal pHE does not pass through the pulse width shortening circuit γ1. Furthermore, as described in detail later with regard to the second embodiment, a pulse width extension circuit γ2 that increases the pulse width may be incorporated in the wiring arrangement. For example, the pulse width of the discharging heat enable signal tHE may be increased by the pulse width extension circuit. That is, if the pulse width of the signal whose power consumption is desired to be reduced is relatively reduced, the balance of the total power consumption of the discharge element substrate α0 can be adjusted, and therefore, problems of insufficient power and excessive power for the discharging drive element and the circulating drive element can be solved

### (Driving and Control of Discharging Heater RhA)

Driving and control of the discharging heater RhA in a discharging heater array α9 in FIG. 3 will be described. The discharging heater array α9 is formed by m groups. Each group includes n discharging heaters RhA. The discharging heater RhA is disposed directly below the discharge port for the ink. When one group is selected, the n discharging heaters RhA in the one group are sequentially activated in a time division manner. Driving and control of n (=16)×m (=40 groups) discharging heaters RhA arranged with a density of 600 dpi will be described.

### (Time-Division Control in One Group)

As described above, the discharging heater RhA is included in each discharging module α1. One group includes n discharging heaters RhA. Therefore, one group includes n discharging modules α1. Since n=16 is assumed, sixteen discharging modules α1 are driven in a time division manner by a common time-division selection signal. Time-division driving is a control of dividing the period of one discharge cycle into n (=16) unit times and sequentially selecting one of the discharging modules α1 every unit time. Here, in the same group, a plurality of discharging modules α1 are not selected at the same time. Every discharging module α1 included in the same group is necessarily selected once in one discharge cycle. In such time-division driving, only one wire of the common time-division selection signal wiring α8 is selected. Therefore, by including the decoder circuit α22 in the control data supply circuit α3, the amount of data serially transferred from the main substrate β0 can be further reduced.

### (Decoder Circuit α22: Time-Division Control)

Refer to FIG. 4 again. The decoder circuit α22 in FIG. 4 is a circuit that expands the number of bits of output data from the number of bits q of input data to the q-th power of 2. Specifically, when 4-bit input data is input to the decoder circuit α22, the decoder circuit α22 converts the 4-bit input data into 16-bit (16 is the fourth power of 2) output data. In this process, the output data from the decoder circuit α22 is output as information with only 1 bit of the 16 bits being valid. This allows the time-division driving. Here, all the wires of the common time-division selection signal wiring α8 used for output from the decoder circuit α22 are preferably used for the discharging time-division selection signals unless the common time-division selection signal wiring α8 is used for a special purpose, from the viewpoint of utilization of input data. Note that as the amount of data serially transferred increases, faster serial transfer is needed. Therefore, the cost and size of the signal transmission circuit, the signal receiving circuit and the transmission lines of the main substrate β0 and the discharge element substrate α0 increase. Therefore, the amount of data is preferably minimized.

### (Selective Control of Group)

To selectively drive any of the m groups, an m-bit discharging group selection signal is output from the control data supply circuit α3. When one of the m groups is selected, the n discharging modules α1 included in the one group can be selected at the same time. The same number m of bits of information as the number of groups is serially transferred from the main substrate β0. As described above, the heat enable signal HE, the discharging group selection signal and the discharging time-division selection signal are input to the discharging logic circuit AND1 of the discharging module α1, and thereby the discharging module α1 is selectively controlled so that a current flows through the discharging heater RhA at the corresponding position. Although an example in which n=16 and m=40 are assumed is described in this embodiment, this is not intended to be limiting. For example, n=8 and m=80 are also possible. Alternatively, for example, different nozzle length n=32 and m=40 than in this embodiment are also possible. However, since n is the number of time divisions, n is preferably a value expressed as a power of 2 (n=2, 4, 8, 16, 32, . . . ), in order to use the output signal of the decoder circuit α22 as a selection signal.

### (Driving and Control of Circulating Module α2)

Refer to FIG. 3 again. Driving and control of the circulating heater RhB in a circulating heater array α10 will be described. As with the discharging heater array α9, the circulating heater array α10 is formed by m groups. As with the discharging heater array α9, each group includes n circulating heaters RhB. The circulating heater RhB is arranged in pair with and close to the discharging heater RhA. When one group is selected, the n circulating heaters RhB in the one group are sequentially activated in a time division manner. Driving and control of n (=16)×m (=40 groups) circulating heaters RhB will be described.

### (Time-Division Control in One Group)

The circulating heater RhB is included in each circulating module α2 as described above. One group includes n circulating heaters RhB. Therefore, one group includes n circulating modules α2. Since n=16 is assumed, sixteen circulating modules α2 are driven in a time division manner by the common time-division selection signal. In this embodiment, the number of time divisions for the circulating modules α2 is the same as the number of time divisions for the discharge modules α1 (n=16).

### (Selective Control of Group)

To selectively drive any of the m groups, an m-bit circulating group selection signal is output from the control data supply circuit α3. When one of the m groups is selected, the n circulating modules α2 included in the one group can be selected at the same time. The same number m of bits of information as the number of groups is serially transferred from the main substrate β0. As described above, the heat enable signal HE, the circulating group selection signal and the common time-division selection signal are input to the circulating logic circuit AND2 of the circulating module α2, and thereby the circulating module α2 is selectively controlled so that a current flows through the circulating heater RhB at the corresponding position. However, the circulating group selection signal is transferred from the circulating group control circuit α12 in FIG. 4 via the circulating group selection signal wiring α7. The circulating group control circuit α12 in FIG. 4 is included in the control data supply circuit α3.

### (Circulating Group Control Circuit α12)

The circulating group control circuit α12 in FIG. 4 includes an AND circuit and a NOT circuit. The NOT circuit outputs a signal (referred to as a logically inverted signal, hereinafter) obtained by inverting the logic of the discharging group selection signal from the discharging group selection signal wiring α6. To the AND circuit, the logically inverted signal and a circulation flag signal α13 are input. The circulation flag signal α13 is included in the data signal DATA serially transferred from the controller β1. The circulation flag signal α13 serves as a flag for setting the circulating group selection signal output via the circulating group selection signal wiring α7 to be valid or invalid. In the normal discharge operation that does not require the ink circulation, the circulation flag signal α13 can be set to 0 to prohibit the circulating module α2 from being selected. That is, the circulating group control circuit α12 generates a circulating group selection signal according to selection information of the discharging group selection signal and the circulation flag signal α13. Therefore, when the discharging module α1 is in the selected state, the circulating module α2 is not in the selected state. However, even when the discharging module α1 is not in the selected state, if the circulation flag signal α13 is 0, the circulating group selection signal is invalid, and the circulating module α2 is not in the selected state. That is, when the discharging module α1 is not in the selected state, and the circulation flag signal α13 is 1, the circulating group selection signal is valid, and the circulating module α2 is in the selected state. Note that while a pair of a discharging module α1 and a circulating module α2 is not selected in the time division control, any of the discharging module α1 and the circulating module α2 is not selected.

In this embodiment, the common power supply voltage VH (24 V, for example) is used as the power supply voltage of the discharging module α1 and the circulating module α2, and the common GNDH is used as the ground potential. However, in order to reduce the variation in discharge energy due to the voltage drop occurring when the discharging heater RhA and the circulating heater RhB are driven, the procedure described below is possible. That is, in the discharge element substrate α0, separate supply wiring and external connection terminals for the power supply voltage and the ground potential may be provided for the discharging module α1 and the circulating module α2. That is, the discharging module α1 and the circulating module α2 may be separately supplied with a power supply voltage from the power supply circuit 132 mounted in the main substrate 130.

In general, the drive element is operated with a higher voltage than the logic circuit, and therefore, a substrate is used which includes both a high-voltage-proof drive element and a normal drive element. In this embodiment, the discharging drive element MDI and the circulating drive element MD2 may be formed by a DMOS transistor (double-diffused MOSFET), which is a high-voltage-proof MOS transistor. The discharging logic circuit AND1, the circulating logic circuit AND2, the circulating group control circuit α12, and other logic circuits including the shift registers α20a and α20b, the latch circuits α21a and α21b and the decoder circuit α22 may be formed by a low-voltage-proof MOS transistor.

### (Circuit Footprint)

Next, differences due to the circuit arrangement will be described. The drive current for the circulating heater RhB generates thermal energy for circulating the ink in the individual flow path. When the drive current for the circulating heater RhB is smaller than the drive current for the discharging heater RhA for discharging the ink onto the discharge medium, the current driving capacity of the DMOS transistor can be low. Therefore, the footprint of the discharging drive element MD1 does not have to be larger than the footprint of the circulating drive element MD2, so that the footprint of the circulating drive element MD2 is preferably smaller than the footprint of the discharging drive element MDI.

### (First Example of Circuit Arrangement)

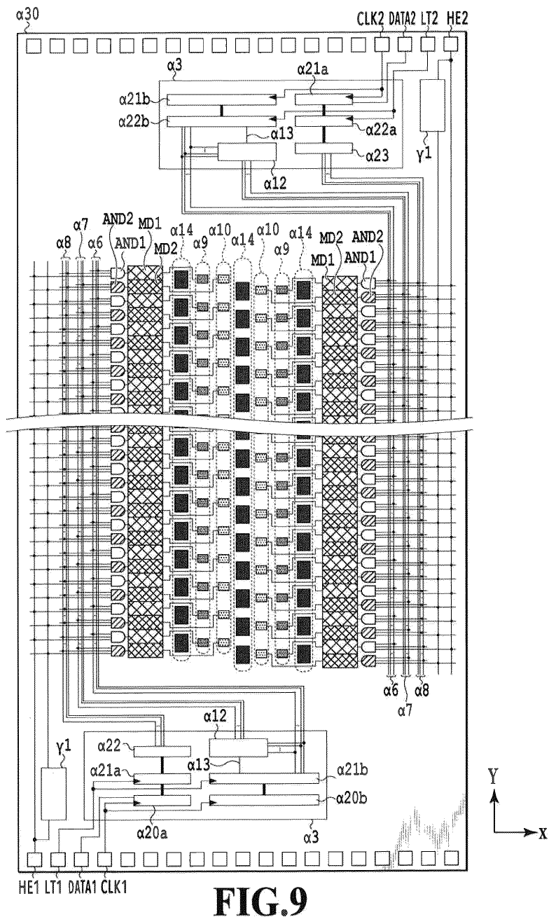

FIG. 9 is a plan view of a discharge element substrate α30. In the example in FIG. 9, two systems of mechanisms to be selectively controlled are arranged in point symmetry with respect to the center of the discharge element substrate α30, each system including mechanisms from the control data supply circuit α3 to the discharging heater array α9 and the circulating heater array α10. In FIG. 9, three ink supply port arrays α14 extending in the conveyance direction Y are arranged at intervals in the direction X. Between the adjacent ink supply port arrays α14, one discharging heater array α9 and one circulating heater array α10 are arranged along the conveyance direction Y. In each of the region to the left of the left-side ink supply port array α14 of the three ink supply port arrays α14 and the region to the right of the right-side ink supply port array α1 4, the following components are arranged. That is, the discharging drive element MD1, the circulating drive element MD2, the discharging logic circuit AND1, the circulating logic circuit AND2, the discharging group selection signal wiring α6, the circulating group selection signal wiring α7 and the common time-division selection signal wiring α8 are arranged. In each of the region to the left of the left-side ink supply port array α14 and the region to the right of the right-side ink supply port array α14, the transmission wiring for the discharging heat enable signal tHE and the transmission wiring for the circulating heat enable signal pHE are also arranged.

External connection terminals are arranged along the direction X at two ends of the discharge element substrate α30 in the conveyance direction Y. In each of the regions between the external connection terminals and the ink supply port arrays α14, the control data supply circuit α3 is arranged. Two control data supply circuits α3 and two pulse width shortening circuits γ1 are arranged in two separate regions in the conveyance direction Y, since there are two regions between the external connection terminals and the ink supply port arrays α14 in the conveyance direction Y.

As described above with reference to FIG. 9, the discharge element substrate α30 is configured with constituent elements arranged in the conveyance direction Y, and therefore, the dimension of the discharge element substrate α30 in the direction X can be reduced. Although not shown, by regarding the arrangement of the discharge element substrate α30 as one unit, if a plurality of discharge element substrates α30 are arranged in the direction X, one liquid discharge head 1 can accommodate a plurality of types of inks.

The elements on the discharge element substrate α30 can be integrally and finely produced by the semiconductor process technology, and this holds true for the other embodiments. The pulse width shortening circuit γ1 can also be produced by the semiconductor process technology. The pulse width shortening circuit γ1 can be easily reduced in size, since the pulse width shortening circuit γ1 has a simple configuration formed by a delay circuit and an AND circuit. Therefore, the pulse width shortening circuit γ1 can also be easily arranged in the discharge element substrate α30. Therefore, the increase in size of the discharge element substrate α30 can be prevented, and the manufacturing cost of the discharge element substrate α30 can be reduced.

Compared with the case where separate external terminals for receiving heat enable signals are provided in order to change the pulse width for each of the discharging heater RhA and the circulating heater RhB, the number of pads can be reduced. In addition, the wiring for the heat enable signals HE outside of the discharge element substrate α30 can also be reduced, and therefore, the increase of the cost of the liquid discharge head 1 can be reduced. In addition, by shortening the wiring for the heat enable signals HE outside of the discharge element substrate α30, crosstalk between signals can be reduced.

### Second Embodiment

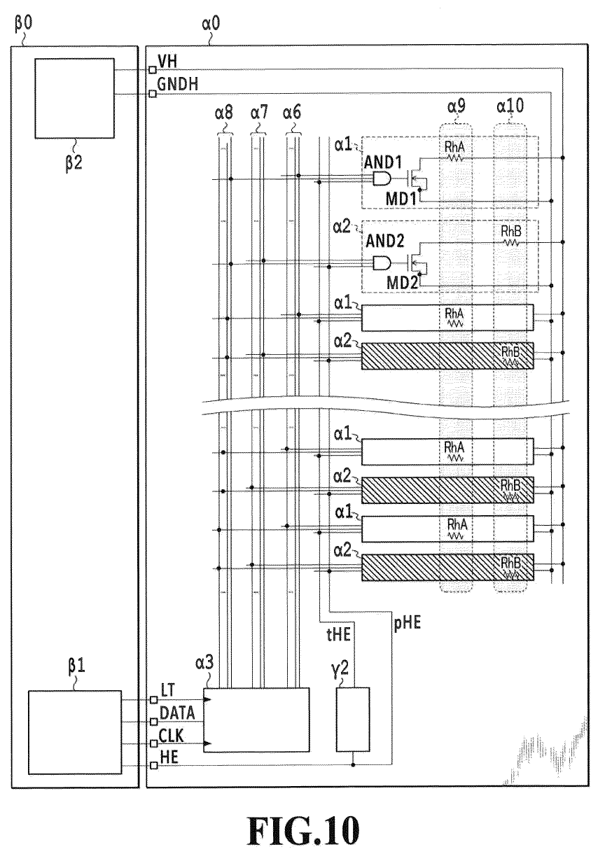

FIG. 10 is a diagram showing an example general configuration of a liquid discharge apparatus according to a second embodiment. The second embodiment differs from the first embodiment in that a pulse width extension circuit γ2 is arranged instead of the pulse width shortening circuit γ1. In the following, differences from the first embodiment will be described, and description of the same components and functions as those in the first embodiment will be omitted.

### (Pulse Width Extension Circuit γ2)

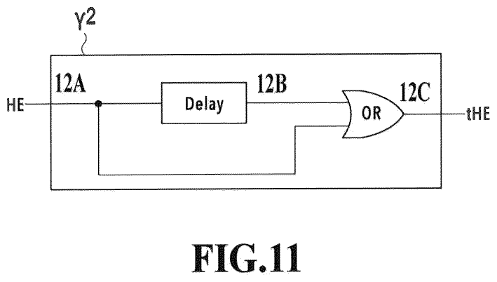

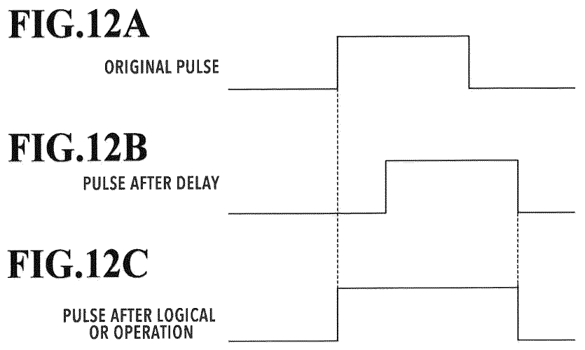

FIG. 11 is a diagram showing an example of a circuit configuration of the pulse width extension circuit γ2 in FIG. 10. FIG. 12 is a diagram showing an example change of a pulse in the pulse width extension circuit. As shown in FIG. 11, the pulse width extension circuit γ2 includes a delay circuit and an OR circuit. FIG. 12A is a diagram showing a pulse shape at (a) in FIG. 11. FIG. 12B is a diagram showing a pulse shape at (b) in FIG. 11. FIG. 12C is a diagram showing a pulse shape at (c) in FIG. 11. Here, it is assumed the pulse width of the heat enable signal HE is 0.8 μs. In addition, when the heat enable signal HE is input to the pulse width extension circuit γ2, the heat enable signal HE is split before being input to the delay circuit. One of the split signals is input to the delay circuit, and the other split signal bypasses the delay circuit and is input to the OR circuit. The OR circuit receives the signal input thereto by bypassing the delay circuit and the signal output from the delay circuit. Compared with FIG. 12A, the rising edge of the heat enable signal HE in FIG. 12B, which has passed through the delay circuit, is delayed by 0.2 μs, for example. Therefore, the pulse width of the signal output from the OR circuit is 1.0 μs. That is, the pulse width of the discharging heat enable signal tHE is 1.0 μs, while the pulse width of the circulating heat enable signal pHE is 0.8 μs.

### (Delay Circuit)

As with the delay circuit in the first embodiment shown in FIG. 7, the delay circuit in FIG. 11 includes a plurality of inverter circuits. It is assumed that the pulse width of the heat enable signal HE is 0.8 μs, and the delay amount of one inverter circuit is 10 ns. On this assumption, when twenty inverter circuits are connected in series, the pulse of the signal is delayed by 0.2 μs compared with the original pulse. That is, the signal at the position (b) in FIG. 11 is delayed by 0.2 μs compared with the signal at the position (a) in FIG. 11. Therefore, the pulse width of the signal at the position (c) in FIG. 11, which is the logical sum of the signal at the position (a) in FIG. 11 and the signal at the position (b) in FIG. 11, is 1.0 μs. As a result, the pulse width of the circulating heat enable signal pHE is 0.8 μs, and the pulse width of the discharging heat enable signal tHE is 1.0 μs. Note that as in the first embodiment, the number of the inverter circuits connected to each other is not limited to twenty.

As can be seen from the above description, the discharging heat enable signal tHE having passed through the pulse width extension circuit γ2 has a longer pulse width than the circulating heat enable signal pHE that does not pass through the pulse width extension circuit γ2, and these signals can have different pulse widths. Although this embodiment has been described with reference to an example in which the pulse width of the discharging heat enable signal tHE is increased by the pulse width extension circuit γ2, this is not intended to be limiting. A wiring arrangement is also possible in which the circulating heat enable signal pHE passes through the pulse width extension circuit γ2 and the discharging heat enable signal tHE does not pass through the pulse width extension circuit γ2. Furthermore, not only the pulse width extension circuit γ2 but also the pulse width shortening circuit γ1 in the first embodiment described above may be incorporated in the wiring arrangement. That is, if the pulse width of the signal whose power consumption is desired to be reduced is relatively shortened, the balance of the overall power consumption of the discharge element substrate α0 can be adjusted. Therefore, the power shortage and surplus power of each of the discharging drive element and the circulation drive element can be solved.

### Third Embodiment

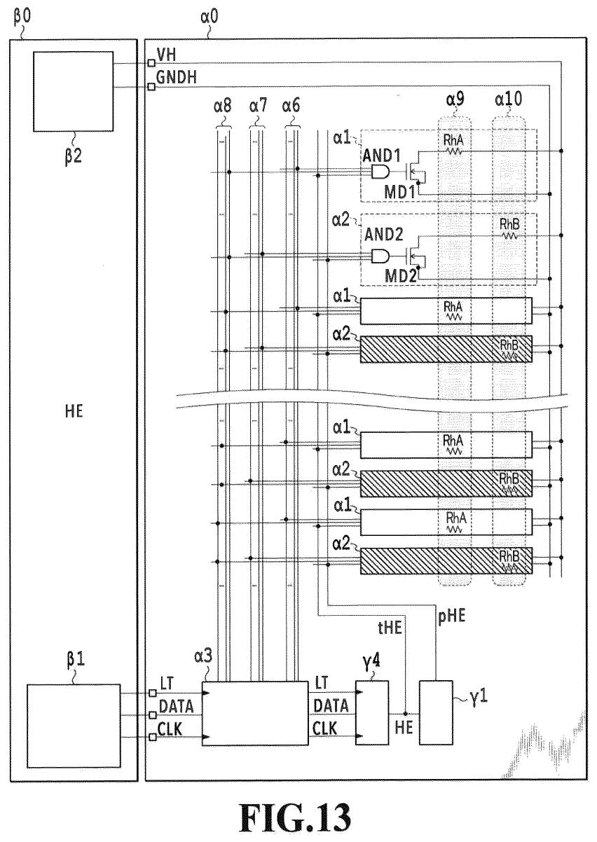

FIG. 13 is a diagram showing an example general configuration of a liquid discharge apparatus according to a third embodiment. The third embodiment differs from the first and second embodiments in that no external input terminal for receiving the heat enable signal HE is provided, since the heat enable signal HE is not transmitted from the main substrate β0. The third embodiment also differs from the first and second embodiments in that the discharge element substrate α0 includes a pulse width generating circuit γ4 that generates a heat enable signal HE, since the heat enable signal HE is not transmitted from the main substrate β0. In the following, differences from the first and second embodiments will be described, and description of the same components and functions as those in the first and second embodiments will be omitted.

### (Pulse Width Generating Circuit γ4)

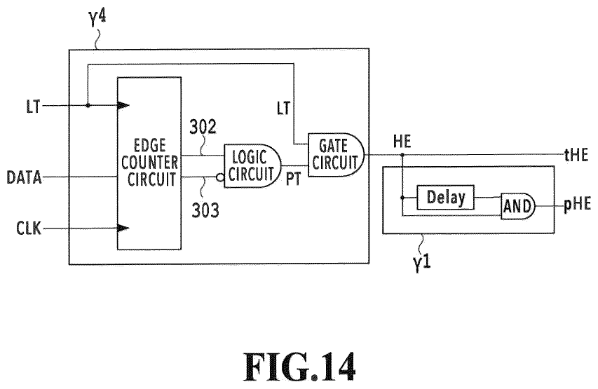

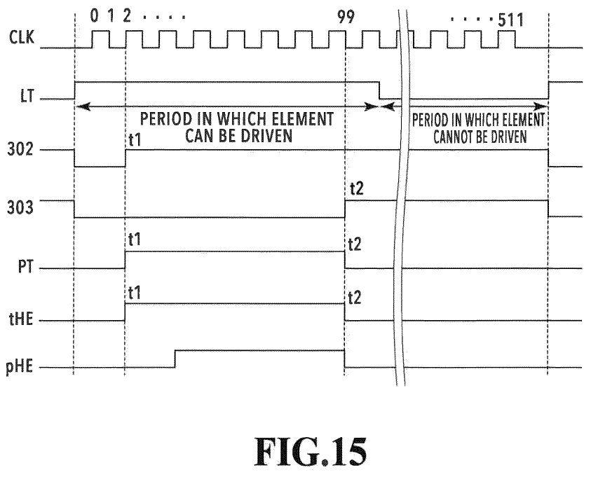

The discharge element substrate α0 in FIG. 13 includes a pulse width generating circuit γ4. The clock signal CLK, the data signal DATA and the latch signal LT are transmitted from the controller β1 to the pulse width generating circuit γ4 through the control data supply circuit α3. The pulse width generating circuit γ4 generates a heat enable signal HE. The heat enable signal HE generated by the pulse width generating circuit γ4 is split. One of the split signals resulting from the splitting of the heat enable signal HE is transmitted as a discharging heat enable signal tHE. The other signal resulting from the splitting of the heat enable signal HE passes through the pulse width shortening circuit γ1 and is then transmitted as a circulating heat enable signal pHE. FIG. 14 is a diagram showing an example of the circuit configuration of the pulse width generating circuit γ4 in FIG. 13. FIG. 15 is a diagram showing an example change of a pulse in the pulse width generating circuit γ4 in FIG. 14. The pulse width generating circuit γ4 includes an edge counter circuit, a logic circuit and a gate circuit. To the edge counter circuit, the data signal DATA is input as timing data of the heat enable signal HE. In the data signal DATA, the rising timing and the falling timing of a PT signal are defined. In addition, the data signal DATA is set in the edge counter circuit at the rising timing of the LT signal. The edge counter circuit counts the edges of the clock signal CLK. For example, the edge counter circuit starts counting based on the data signal DATA in synchronization with an edge of the clock signal CLK. When the edge counter circuit ends counting, the edge counter circuit outputs a carry signal 302 and a carry signal 303 and stops operating. The carry signal 302 and a result of logical negation of the carry signal 303 are input to the logic circuit. The logic circuit outputs a PT signal. The gate circuit outputs the result of AND operation of the input PT signal and the LT signal as a heat enable signal HE. The output heat enable signal HE is split. One of the split signals is output as a discharging heat enable signal tHE without change. The other of the split signals is input to the pulse width shortening circuit γ1, reduced in pulse width and then output as a circulating heat enable signal pHE. In this way, the pulse width of the discharging heat enable signal tHE and the pulse width of the circulating heat enable signal pHE can be different. The pulse width shortening circuit γ1 used for the circulating heat enable signal pHE is not intended to be limiting. For example, a pulse width extension circuit γ2 may be used for the discharging heat enable signal tHE. Alternatively, the pulse width shortening circuit γ1 may be used for the discharging heat enable signal tHE.

As can be seen from the above description, according to this embodiment, the pads of the external input terminals for the heat enable signal HE and the wiring for the heat enable signal HE outside of the discharge element substrate α0 can be reduced, compared with the first and second embodiment. Therefore, the increase of the cost of the liquid discharge head 1 can be further reduced. In addition, since no wiring for the heat enable signal HE is needed outside of the discharge element substrate α0, crosstalk between signals can be reduced.

Note that although in any of the first to third embodiments, different pulse widths are used for the set of the discharging heater RhA and the circulating heater RhB, this is not intended to be limiting. For example, different pulse widths may be used for discharging heaters of different sizes, such as a large discharging heater and a small discharging heater.

Alternatively, different pulse widths may be used for a heating element (sub heater) for keeping the discharge element substrate α0 at a certain temperature and the discharging heater RhA. Alternatively, different pulse widths may be used for a temperature detecting element (temperature sensor) capable of detecting the temperature in a bubble generation chamber and the discharging heater RhA. The pulse width can be adjusted for any other possible combination of heating elements.

The first embodiment has been described with reference to an example in which the pulse width shortening circuit γ1 is used, the second embodiment has been described with reference to an example in which the pulse width extension circuit γ2 is used, and the third embodiment has been described with reference to an example in which the pulse width generating circuit γ4 and the pulse width shortening circuit γ1 are used. These adjustments of the pulse width may be used in combination, or an entity having one of these pulse width adjustment functions may be referred to as a pulse width adjusting circuit. For example, in the first embodiment, an entity including the pulse width shortening circuit γ1 may be referred to as a pulse width adjusting circuit. In the second embodiment, an entity including the pulse width extension circuit γ2 may be referred to as a pulse width adjusting circuit. In the third embodiment, an entity including the pulse width generating circuit γ4 and the pulse width shortening circuit γ1 may be referred to as a pulse width adjusting circuit.

### Other Embodiments

Although various examples and embodiments of the present disclosure have been described above, the spirit and scope of the present disclosure are not limited to the specific description in this specification. The present disclosure is not limited to the embodiments described above, and various modifications can be made. In addition, parts of the embodiments of the present disclosure described above may be combined as required.

### (Variation 1)

For example, although the pulse width shortening circuit γ1 has been described in the first embodiment, the pulse width extension circuit γ2 has been described in the second embodiment, and an example combination of the pulse width shortening circuit γ1 and the pulse width generating circuit γ4 has been described in the third embodiment, this is not intended to be limiting. For example, at least two of the pulse width shortening circuit γ1, the pulse width extension circuit γ2 and the pulse width generating circuit γ4 may be combined. Alternatively, the liquid discharge head 1 may include at least one pulse width adjusting circuit that has all the functions of the pulse width shortening circuit γ1, the pulse width extension circuit γ2 and the pulse width generating circuit γ4. For example, a dual inline package (DIP) switch for the pulse width adjusting circuit to switch whether to use the functions of the pulse width shortening circuit γ1, the pulse width extension circuit γ2 and the pulse width generating circuit γ4 may be provided. In this case, by appropriately setting the DIP switch to set the combination of the functions of the pulse width adjusting circuit, any pulse width adjustment can be implemented. Alternatively, different numbers of pulse width shortening circuits γ1, pulse width extension circuits γ2 and pulse width generating circuits γ4, such as a plurality of pulse width shortening circuits γ1 and one pulse width generating circuit γ⁴, may be combined.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, the driving power can be appropriately supplied to each of the discharging drive element and the circulating drive element.

This application claims the benefit of Japanese Patent Application No. 2024-166303, filed Sep. 25, 2024, which is hereby incorporated by reference herein in its entirety.

What is claimed is:

1. A liquid discharge head, comprising:
a discharging module for having a discharging drive element and a discharging heater capable of being electrically connected to the discharging drive element;
a circulating module for being arranged in pair with the discharging module and for having a circulating drive element and a circulating heater capable of being electrically connected to the circulating drive element; and
a pulse width controller for differentiating a discharging pulse width for controlling the discharging drive element to a conductive state from a circulating pulse width for controlling the circulating drive element to a conductive state.

2. The liquid discharge head according to claim 1, wherein the pulse width controller controls at least one of the discharging pulse width and the circulating pulse width.

3. The liquid discharge head according to claim 1, wherein the pulse width controller controls any of the discharging pulse width and the circulating pulse width.

4. The liquid discharge head according to claim 3, wherein the pulse width controller includes a pulse width shortening circuit which sets as the circulating pulse width a pulse width of being obtained by shortening a heat enable signal which determines a reference drive pulse width common to the discharging drive element and the circulating drive element.

5. The liquid discharge head according to claim 3, wherein the pulse width controller includes a pulse width extension circuit which sets as the discharging pulse width a pulse width of being obtained by extending a heat enable signal which determines a reference drive pulse width common to the discharging drive element and the circulating drive element.

6. The liquid discharge head according to claim 3, wherein the pulse width controller includes:
a pulse width generating circuit for generating a heat enable signal for determining a reference drive pulse width common to the discharging drive element and the circulating drive element; and
a pulse width shortening circuit for setting as the circulating pulse width a pulse width of being obtained by shortening the heat enable signal being generated by the pulse width generating circuit.

7. The liquid discharge head according to claim 4, wherein the pulse width shortening circuit includes:
a delay circuit for delaying the heat enable signal; and
a logical AND operation circuit for outputting a logical product of a signal delayed by the delay circuit and the heat enable signal.

8. The liquid discharge head according to claim 5, wherein the pulse width extension circuit includes:
a delay circuit for delaying the heat enable signal; and
a logical OR operation circuit for outputting a logical sum of a signal delayed by the delay circuit and the heat enable signal.

9. The liquid discharge head according to claim 7, wherein the delay circuit includes a plurality of inverter circuits, and each of the plurality of inverter circuits is connected in series.

10. The liquid discharge head according to claim 7, wherein the delay circuit includes a resistor and a capacitor, and the resistor and the capacitor are connected in series.

11. The liquid discharge head according to claim 9, wherein an amount of delay of the delay circuit is 0.2 μs or less, and a difference between the discharging pulse width and the circulating pulse width is 0.2 μs or less.

12. The liquid discharge head according to claim 10, wherein an amount of delay of the delay circuit is 0.2 μs or less, and a difference between the discharging pulse width and the circulating pulse width is 0.2 μs or less.

13. The liquid discharge head according to claim 6, wherein the pulse width generating circuit determines the driving pulse width based on a count value obtained by counting edges of an input clock signal.

14. The liquid discharge head according to claim 1, wherein a plurality of discharging modules and a plurality of circulating modules are provided, the number of the discharging modules being equal to the number of the circulating modules, and
the liquid discharge head further comprises a control data supplier for exclusively selecting a circulating group or a discharging group, the circulating group being formed by dividing the plurality of circulating modules into circulating groups each including a predetermined number of circulating modules, and the discharging group being formed by dividing the plurality of discharging modules into discharging groups each including the predetermined number of discharging modules.

15. The liquid discharge head according to claim 1, wherein a common power supply voltage and a common ground potential are connected to the discharging heater and the circulating heater.

16. The liquid discharge head according to claim 1, wherein the discharging heater and the circulating heater are produced in a same semiconductor process.

17. The liquid discharge head according to claim 1, wherein the discharging heater and the circulating heater are made from a same material.

18. A liquid discharge apparatus, comprising:
a liquid discharge head;
a carriage for mounting the liquid discharge head and for reciprocating in a main scan direction; and
a conveyance roller for being provided below the carriage and for conveying a discharge target medium in a sub scan direction,
wherein the liquid discharge head comprises:
a discharging module which has a discharging drive element and a discharging heater capable of being electrically connected to the discharging drive element;
a circulating module which is arranged in pair with the discharging module and has a circulating drive element and a circulating heater capable of being electrically connected to the circulating drive element; and
a pulse width controller which differentiates a discharging pulse width for controlling the discharging drive element to a conductive state from a circulating pulse width for controlling the circulating drive element to a conductive state.
